(19) United States
(12) Patent Application Publication
(10) Pub. No.: US 2010/0277154 A1
(43) Pub. Date: Nov. 4, 2010

(54) CASCADE DEVICE WITH A VOLTAGE REGULATING EFFECT

(76) Inventors: Yen-Hui WANG, Hsinchu City (TW); Chia-Chieh HUNG, Lujhu Township (TW)

Correspondence Address: NORTH AMERICA INTELLECTUAL PROPERTY CORPORATION, P.O. BOX 506, MERRIFIELD, VA, 22116, US

(21) Appl. No.: 12/433,621

(22) Filed: Apr. 30, 2009

(51) Int. Cl. G05F 5/00

(52) U.S. Cl. 323/299

(57) ABSTRACT

The present invention discloses a cascade device with a voltage regulating effect. The cascade device can be applied to a power supply of a cascade structure and includes a comparing element and a power control element. The comparing element provides for inputting a sampling voltage and a reference voltage, and outputs a control signal to the power control element when the sampling voltage is larger than the reference voltage. Next, the power control element can control an input voltage to be outputted to grounding, according to the control signal. Therefore, a control circuit can be provided with a stable voltage source, without requiring an extra rectifying device.

### BACKGROUND OF THE INVENTION

a) Field of the Invention

The present invention relates to a cascade device and more particularly to a cascade device with a voltage regulating effect, which is able to control a voltage source for outputting a stable voltage, such that no extra rectifying device is needed inside a control circuit.

b) Description of the Prior Art

As a light emitting diode is provided with advantages of having a high illumination efficiency, a long service time, not being damaged easily, consuming less electricity, being environmental friendly and having a small volume, it has been one of the most important light sources in recent years. In early years, as the light emitting diode does not have sufficient luminance, it was often used in an indicating lamp or a display panel. However, due to recent breakthrough in material science and technology, the luminance of the light emitting diode has already been improved significantly, especially that as a white-light light emitting diode emerges, existing conventional illuminating equipment has been gradually replaced by the light emitting diode.

On the other hand, as more and more applications of the light emitting diodes, a power supply circuit which drives the light emitting diodes is becoming very important. The power supply circuit can properly provide a stable power source to the light emitting diodes, allowing the light emitting diodes to illuminate stably. Whereas in order to reduce a cost and circuit space, many vendors will integrate the power supply circuit into an integrated circuit that by only using the power supply integrated circuit, the light emitting diodes can be effectively driven to illuminate.

However, when using the aforementioned power supply circuit, following issues and shortcomings actually exist to be improved.

In the power supply circuit, there is usually a control circuit to control a power source of the power supply circuit. Referring to FIG. 1, it shows a circuit diagram of a conventional power supply circuit, wherein the power supply circuit 1 is provided with a control circuit 11, a voltage source 12 (VDD, Voltage Drain Drain) which provides the power source to the control circuit 11, an input voltage 15 which comes from an input power source 13 and is then divided through a resistor 14, a power transistor 16 and a light emitting diode 17. As the voltage source 12 which supplies the control circuit 11 is equal to a sum of a voltage drop of the power transistor 16 and a voltage drop of the light emitting diode 17 subtracted from the input voltage 15, and each electronic element is provided with a temperature coefficient, any replacement of the electronic element will result in a change of the voltage source 12; thus, it is always unable to have the stable voltage source 12 to provide the control circuit 11 with electricity.

Accordingly, how to solve the aforementioned issues and shortcomings of the prior art is to be studied and researched for improvement by the present inventor and related industries

### SUMMARY OF THE INVENTION

The primary object of the present invention is to provide a cascade device which is able to control a voltage source to output a stable voltage, such that no extra rectifying device is needed for a control circuit.

The present invention can be applied to a power supply of a cascade structure and to achieve the aforementioned object, includes a comparing element and a power control element. The comparing element includes a first input end, a second input end and an output end, wherein the first input end provides for inputting a sampling voltage, the second input end provides for inputting a reference voltage, and the output end can output a control signal when the sampling voltage is larger than the reference voltage. The power control element includes an input end, a power source end and a grounding end, wherein the input end provides for inputting the control signal, the power source end provides for receiving an input voltage, and the grounding end can control the input voltage to be outputted to grounding, according to the control signal.

By the aforementioned structures, when the sampling voltage which is inputted to the first input end of the comparing element is larger than the reference voltage which is inputted to the second input end of the comparing element, the output end of the comparing element will output the control signal to the power control element, and the power control element will control the input voltage to be outputted to grounding, according to the inputted control signal. Therefore, the voltage source can be effectively controlled to output a stable voltage, without requiring an extra rectifying device.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a circuit diagram of a conventional power supply circuit.

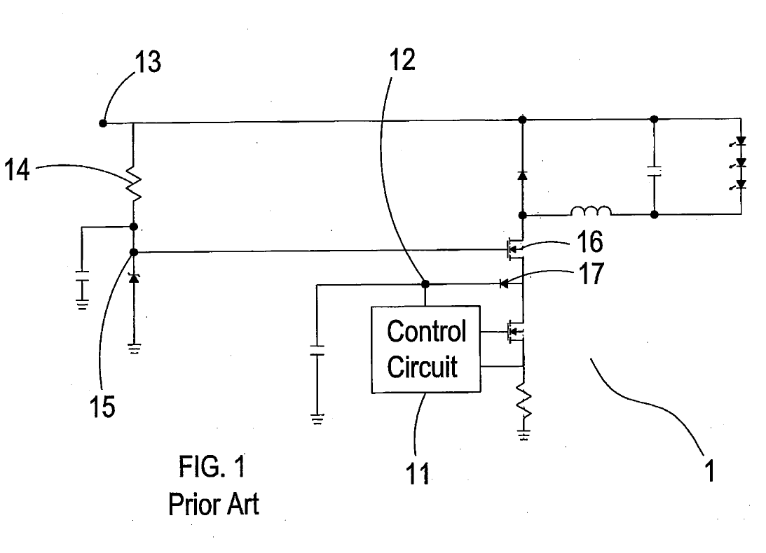

FIG. 2 shows a schematic view of an implementation of a preferred embodiment of the present invention.

FIG. 3 shows a change of voltage source with respect to time, according to FIG. 2.

FIG. 4 shows a schematic view of another implementation of a preferred embodiment of the present invention.

FIG. 5 shows a change of voltage source with respect to time, according to FIG. 4.

### DETAILED DESCRIPTION OF THE PREFERRED EMBODIMENTS

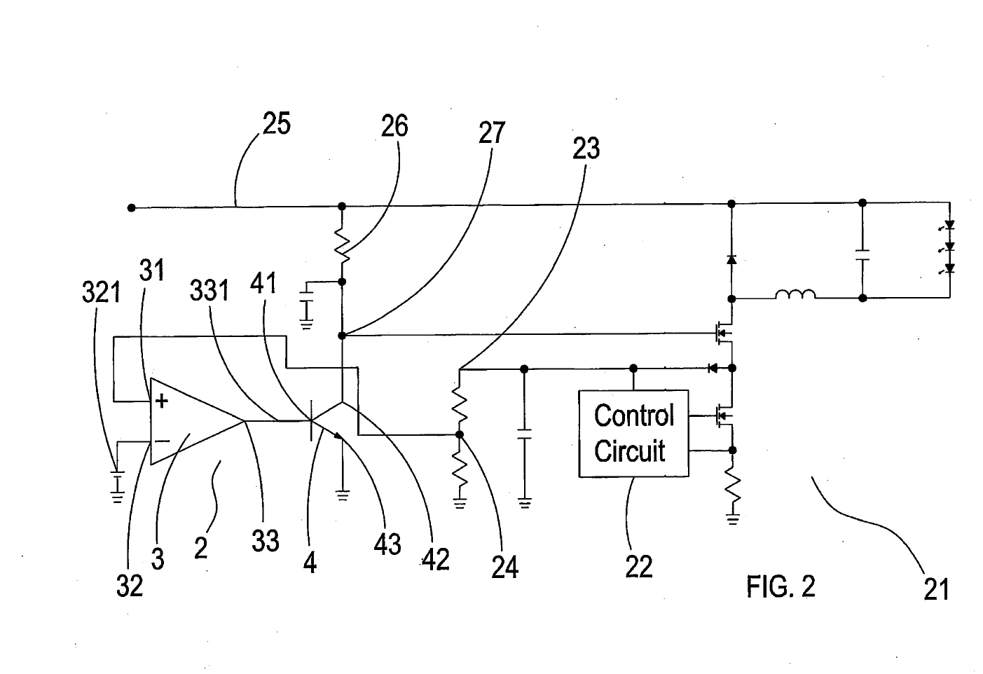

Referring to FIG. 2, it shows a schematic view of an implementation of a preferred embodiment of the present invention, wherein a cascade device 2 of the present invention, which is able to be applied to a power supply of a cascade structure, comprises a comparing element 3, which can be a comparator and includes a first input end 31 for inputting a sampling voltage 24, a second input end 32 for inputting a reference voltage 321, and an output end 33 for outputting a control signal 331 when the sampling voltage 24 is larger than the reference voltage 321; and a power control element 4, which can be a transistor and includes an input end 41 for inputting the control signal 331, a power source end 42 for receiving an input voltage 27, and a grounding end 43 for controlling the input voltage 27 to be outputted to grounding, according to the control signal 331.

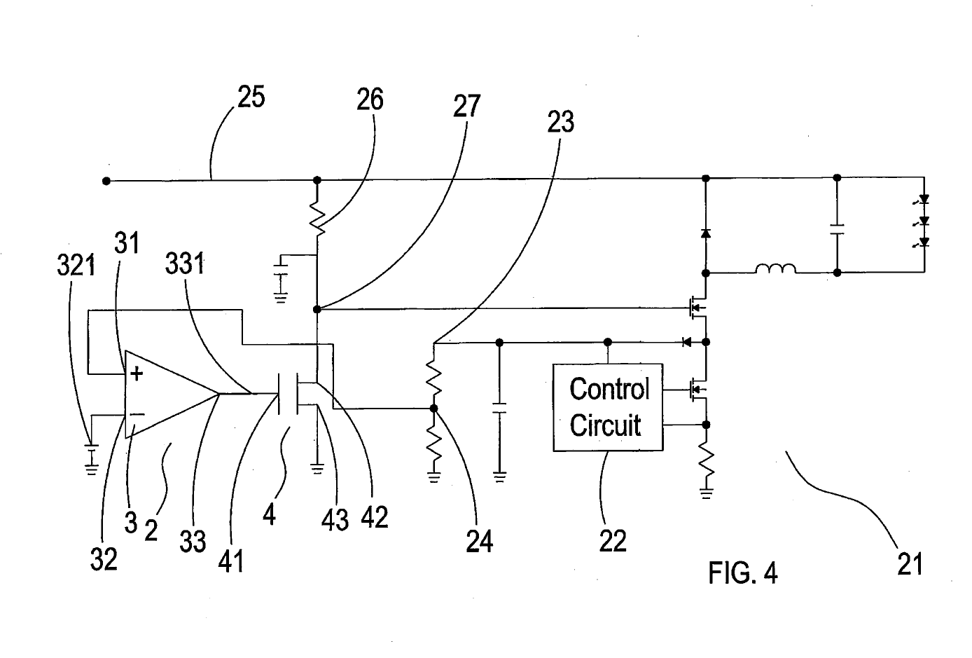

Referring to FIG. 4, it shows a schematic view of an implementation of another preferred embodiment of the present invention. As shown in the drawing, the present embodiment only differs from the previous embodiment by that the comparing element 3 is replaced by an operational amplifier, and the power control element 4 is replaced by a power transistor.

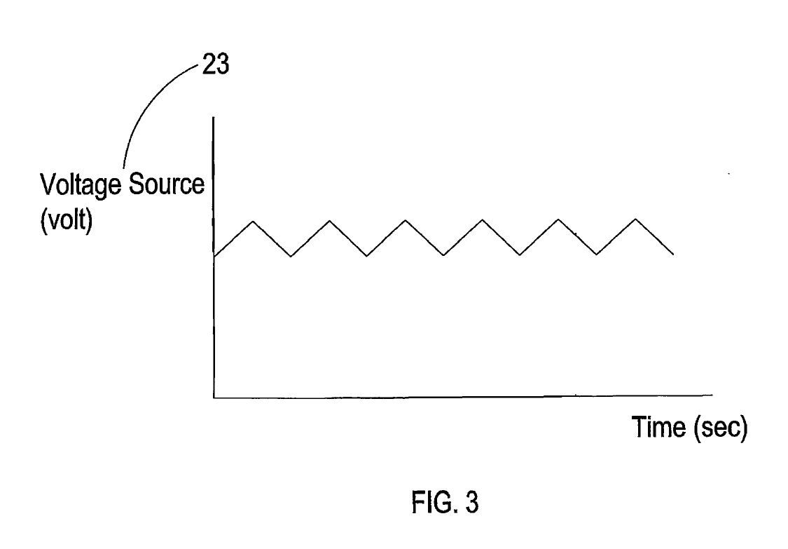

Referring to FIG. 2 and FIG. 3, it shows a schematic view of an implementation of a preferred embodiment of the present invention, and a change of voltage source with respect to time, according to FIG. 2, wherein the cascade device 2 of the present invention can be applied to a power supply circuit 21 of a cascade structure, an interior of the power supply circuit 21 is provided with a control circuit 22, a voltage source 23 (VDD) which provides power to the control circuit 22, the sampling voltage 24 which is divided through a resistor 26, and the input voltage 27 which comes from an input power source 25 and is then divided through the resistor 26. When the power supply circuit 21 operates, as the input voltage 27 will rise slowly, the sampling voltage 24 will also rise slowly. When the sampling voltage 24 is larger than the reference voltage 321, the comparing element 3 will send out the control signal 331 to the power control element 4, wherein the comparing element 3 is the comparator and the control signal 331 is a high-level voltage. In the present embodiment, the power control element 4 is the transistor and is used as a switch. When the power control element 4 receives the control signal 331, the power control element 4 is turned on, allowing the input voltage 27 at the power source end 42 of the power control element 4 to drop, further enabling the sampling voltage 24 to drop as well; on the other hand, when the sampling voltage 24 is smaller than the reference voltage 321, the power control element 4 is turned off and at this time, the sampling voltage 24 rises slowly again, and the voltage source 23 also rises slowly. This procedure repeats continuously (as shown in FIG. 3). By this circuit, the voltage source 23 will rise and drop repeatedly in a range, so as to achieve the stable voltage source 23.

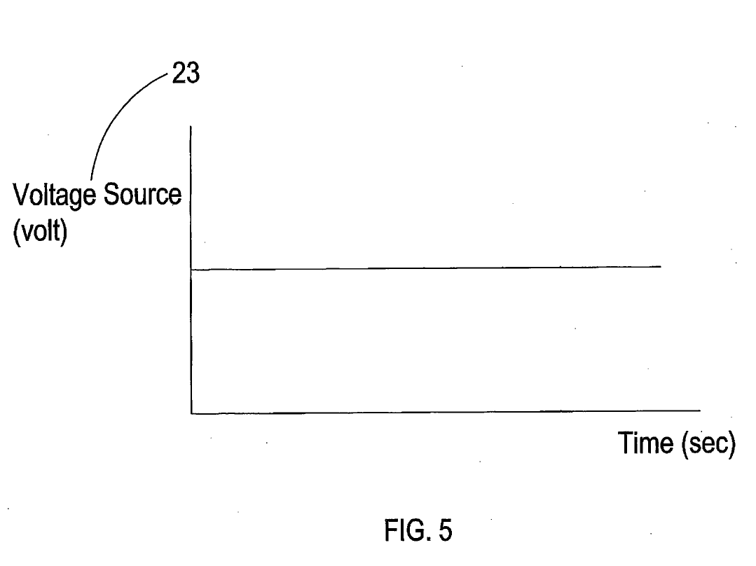

Referring to FIG. 4 and FIG. 5, it shows a schematic view of an implementation of another preferred embodiment of the present invention, and a change of voltage source with respect to time, according to FIG. 4. As shown in the drawings, the present embodiment only differs from the previous embodiment by that the comparing element 3 is replaced by an operational amplifier and the power control element 4 is replaced by a power transistor. When the power supply circuit 21 operates, as the input voltage 27 will rise slowly, the sampling voltage 24 will rise slowly, as well. When the sampling voltage 24 is larger than the reference voltage 321, the comparing element 3 will send out the control signal 331 to the power control element 4. In the present embodiment, the comparing element 3 is the operational amplifier and the control signal 331 can control a magnitude of conduction of the power control element 4, so as to acquire the stable input voltage 27, and further achieve the stable voltage source 23 (as shown in FIG. 5).

Accordingly, the key technologies that the cascade device with the voltage regulating effect, in accordance with the present invention, is able to improve the prior art, are that the cascade device 2 of the present invention can be applied to the power supply of the cascade structure and includes the comparing element 3 and the power control element 4, wherein the comparing element 3 provides for inputting the sampling voltage 24 and the reference voltage 321, and outputting the control signal 331 to the power control element 4 when the sampling voltage 24 is larger than the reference voltage 321; whereas, the power control element 4 can receive the input voltage 27 and control the input voltage 27 to be outputted to grounding, according to the control signal 331. Therefore, the control circuit 22 of the present invention can be provided with the stable voltage source 23 and no extra rectifying device will be needed for the control circuit 22, allowing the power supply system to be provided with more flexibility in the circuit application and effectively saving a cost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A cascade device with a voltage regulating effect, which is used in a power supply of a cascade structure, comprising a comparing element which includes a first input end for inputting a sampling voltage, a second input end for inputting a reference voltage, and an output end for outputting a control signal when the sampling voltage is larger than the reference voltage; and a power control element, which provides for inputting the control signal and controls an input voltage according to the control signal, and includes an input end for inputting the control signal, a power source end for receiving the input voltage and a grounding end for controlling the input voltage to be outputted to grounding, according to the control signal.

2. The cascade device with a voltage regulating effect, according to claim 1, wherein the comparing element is a comparator and the power control element is a transistor.

3. The cascade device with a voltage regulating effect, according to claim 1, wherein the comparing element is an operational amplifier and the power control element is a power transistor.

4. The cascade device with a voltage regulating effect, according to claim 2, wherein the control signal is a high-level voltage.
